(19) United States
(12) Patent Application Publication
(10) Pub. No.: US 2025/0332728 A1
(43) Pub. Date: Oct. 30, 2025

(54) Article Arrangement Determination System and Article Stacking System

(71) Applicant: Daifuku Co., Ltd., Osaka-shi (JP)

(72) Inventors: Masaya Miyamoto, Tokyo (JP); Takahiro Kubo, Tokyo (JP)

(73) Assignee: Daifuku Co., Ltd., Osaka-shi (JP)

(21) Appl. No.: 19/186,946

(22) Filed: Apr. 23, 2025

(30) Foreign Application Priority Data
Apr. 24, 2024 (JP) 2024-070685

(51) Int. Cl. B25J 9/16; B65G 57/04; B65G 57/24; B65G 57/26; G06T 1/00

(52) U.S. Cl. CPC B25J 9/1687; B65G 57/04; B65G 57/24; B65G 57/26; G06T 1/0014

(57) ABSTRACT

An article arrangement determination system includes a determination processor and a modification processor. The determination processor obtains lower-layer arrangement information indicating lower-layer article arrangement that is arrangement of articles included in a lower article layer and upper-layer arrangement information indicating upper-layer article arrangement that is arrangement of articles included in an upper article layer. The determination processor determines, in response to the lower-layer article arrangement having an open area, whether an article included in the upper article layer has a possibility of falling into the open area. The modification processor modifies the upper-layer arrangement information in response to determination that an article has the possibility of falling. The modification processor determines, in response to upper-layer article arrangement indicated by modified arrangement information resulting from modifying the upper-layer article arrangement having no possibility of falling, the modified arrangement information as new upper-layer arrangement information.

### CROSS-REFERENCE TO RELATED APPLICATION

This application claims priority to Japanese Patent Application No. 2024-070685 filed Apr. 24, 2024, the disclosure of which is hereby incorporated by reference in its entirety.

### BACKGROUND OF THE INVENTION

### Field of the Invention

The present invention relates to an article arrangement determination system and an article stacking system.

### Description of Related Art

For example, Japanese Unexamined Patent Application Publication No. 5-105234 (JP 5-105234) describes a technique for an article arrangement determination system. Reference signs in parentheses used hereafter in describing the background are the reference signs in JP 5-1052341.

The system described in JP 5-105234 presets arrangement patterns each for a different type of article to stack multiple types of different-sized articles in multiple layers (multiple levels) on a support (pallet P). More specifically, multiple article arrangement patterns for one layer (one level) are set for each article type. The article arrangement determination system efficiently determines the arrangement of multiple articles on the support by combining several preset arrangement patterns based on ordering information (types of articles to be stacked on the support and the quantity of articles for each type).

When multiple articles are stacked on the support as described above, the arrangement determined for some type of article may have, in at least one layer, an area in which no article is placed and that remains open (open area). After the multiple articles are actually stacked on the support based on the arrangement as determined, one or more articles placed immediately above the open area may fall into the open area. In such a case, for example, the articles falling into the open area as well as their surrounding articles may be damaged, or the stack may collapse.

### SUMMARY OF THE INVENTION

Thus, an article arrangement determination system is awaited for appropriately determining the arrangement of multiple articles to vertically stack, on a support, multiple article layers each including articles of the multiple articles arranged in a planar manner.

An article arrangement determination system according to an aspect of the disclosure is a system for determining arrangement of a plurality of articles to vertically stack, on a support, a plurality of article layers each including articles of the plurality of articles arranged in a planar manner. The article arrangement determination system includes a determination processor and a modification processor. The determination processor obtains lower-layer arrangement information and upper-layer arrangement information. The lower-layer arrangement information indicates lower-layer article arrangement that is arrangement of the articles included in a lower article layer. The upper-layer arrangement information indicates upper-layer article arrangement that is arrangement of the articles included in an upper article layer. The lower article layer is a lower layer of two of the plurality of article layers adjacent to each other vertically. The upper article layer is an upper layer of the two of the plurality of article layers. The determination processor determines, in response to the lower-layer article arrangement indicated by the lower-layer arrangement information having an open area with no article as viewed vertically, whether an article included in the upper article layer has a possibility of falling into the open area. The modification processor modifies the upper-layer arrangement information in response to the determination processor determining that an article has the possibility of falling. The modification processor generates modified arrangement information by modifying the upper-layer article arrangement indicated by the upper-layer arrangement information, causes the determination processor to determine whether an article has the possibility of falling based on the upper-layer article arrangement indicated by the modified arrangement information, and determines the modified arrangement information as new upper-layer arrangement information in response to determination that no article has the possibility of falling.

When the article layers each including multiple articles are stacked vertically on the support, this structure can determine the arrangement of the articles to prevent an article in the upper article layer from falling into the open area in the lower article layer.

When an article is determined to have the possibility of falling into the open area in determining the arrangement of the articles, this structure generates the modified arrangement information by modifying the upper-layer article arrangement indicated by the upper-layer arrangement information to again determine whether an article has the possibility of falling. This structure can thus reliably determine appropriate arrangement of the articles without an article having the possibility of falling into the open area.

Thus, this structure can appropriately determine the arrangement of the multiple articles.

Further features and advantageous effects of the article arrangement determination system and the article stacking system will be apparent from exemplary and nonlimiting embodiments described below with reference to the drawings.

### BRIEF DESCRIPTION OF THE DRAWINGS

FIG. 1 is a plan view of an entire article transport facility.

FIG. 2 is a control block diagram.

FIG. 3 is a side view of an article layer transferrer.

FIG. 4 is a schematic side view of an article layer being transferred.

FIG. 5 is a schematic side view of an article layer being transferred.

FIG. 6 is a schematic side view of an article layer being transferred.

FIG. 7 is a schematic side view of an article layer being transferred.

FIG. 8 is a schematic side view of article layers in an example process performed by a layer order determiner.

FIG. 9 is a schematic side view of article layers in an example process performed by an insertion determiner.

FIG. 10 is a schematic plan view of article layers in an example process performed by a determination processor.

FIG. 11 is a schematic plan view of article layers in an example rotation process.

FIG. 12 is a schematic plan view of article layers in an example moving process.

FIG. 13 is a control flowchart.

### DESCRIPTION OF THE INVENTION

In the example below described with reference to the drawings, an article stacking system (an article arrangement determination system and an article layer transferrer) is used in an article transport facility.

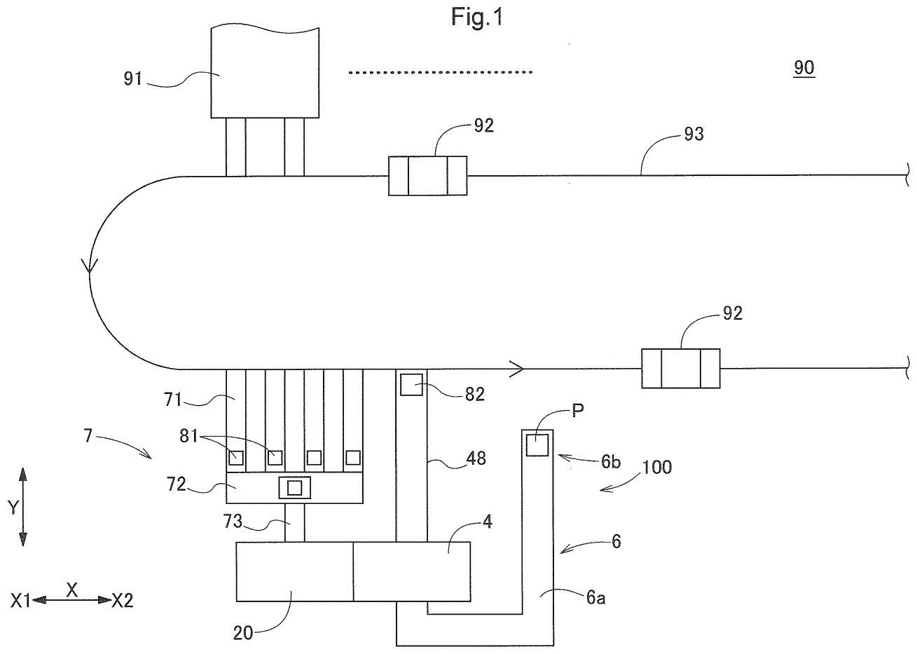

As shown in FIG. 1, an article transport facility 90 includes automated warehouses 91, first transporters 92, and an article stacking system 100. The automated warehouses 91 can store multiple articles W. In this example, the automated warehouses 91 store articles W supported on supports P. The automated warehouses 91 are aligned in the article transport facility 90.

In this example, each support P is a pallet on which articles W can be stacked. The articles W are rectangular as viewed vertically. More specifically, the overall shape of each article W is a rectangular prism. Still more specifically, the articles W are carton containers (cardboard boxes) in this example. These carton containers store, for example, products to be sold in stores. Each automated warehouse 91 stores multiple groups of articles W stacked on the supports P (pallets in this example). The groups of articles W stacked on the supports P are hereafter referred to as stacked article groups. In this example, the stacked article groups also include articles W (e.g., a single article W) placed on a support P as a single level. The overall shape of each article W may also be a cube. The multiple articles W stacked on a support P may be a combination of rectangular prisms and cubes.

The first transporters 92 transport articles W. More specifically, the first transporters 92 can transport the stacked article groups together with the supports P. In this example, the first transporters 92 are transport vehicles that travel along a travel path 93. In this example, a rail (not shown) is installed on the floor along the travel path 93. The first transporters 92 travel as guided by the rail. Each first transporter 92 includes a transferrer (not shown). The transferrer can carry the support P supporting the stacked article group. The transferrer can also receive and transfer such stacked article groups supported on the support P together with the support P. In this example, the transferrer includes a fork, but it may include, for example, a conveyor.

As shown in FIGS. 1 to 3, the article stacking system 100 includes an article arrangement determination system 1 and an article layer transferrer 4. The article stacking system 100 further includes an article layer supplier 20, a shipping article supplier 7, and a support supplier 6. In this example, the article layer transferrer 4 and the article layer supplier 20 are adjacent to each other. The direction in which the article layer transferrer 4 and the article layer supplier 20 are aligned is hereafter referred to as a first direction X. The article layer supplier 20 is disposed on a first side X1 relative to the article layer transferrer 4 in the first direction. The side opposite the first side X1 is a second side X2 in the first direction. The direction perpendicular to the first direction X as viewed vertically is referred to as a second direction Y.

In the illustrated example, the travel path 93 connects the automated warehouses 91 to the shipping article supplier 7. Thus, the first transporters 92 can transport articles W (stacked article groups in this example) between, for example, the automated warehouses 91 and the shipping article supplier 7. The first transporters 92 can also move along the travel path 93 and transport articles W to, for example, destinations external to the article transport facility 90. The article layer supplier 20 is connected to the shipping article supplier 7. The article layer supplier 20 is adjacent to the shipping article supplier 7 in the second direction Y. The article layer transferrer 4 is connected to the article layer supplier 20. The support supplier 6 is connected to the article layer transferrer 4.

In this example, the automated warehouses 91 store multiple articles W of different types, but articles W of the same type are stacked on a single support P. In this example, the articles W (carton containers) containing products of the same type and the same size are referred to as articles W of the same type. In the article transport facility 90, multiple types of articles W are removed from, for example, the automated warehouses 91 to distribute products to stores as shipping destinations. The multiple types of articles W removed from the automated warehouses 91 are stacked on supports P assigned to each store as a shipping destination and then shipped to stores as destinations by, for example, trucks.

The shipping article supplier 7 receives the stacked article groups removed from the automated warehouses 91 as removed article groups 81 to transport the removed article groups 81 to the article layer supplier 20. The shipping article supplier 7 includes multiple first conveyors 71, a second conveyor 73, and a second transporter 72 connecting the first conveyors 71 to the second conveyor 73. The second conveyor 73 connects the second transporter 72 to the article layer supplier 20. The multiple first conveyors 71 are disposed parallel to one another and connected to the travel path 93 of the first transporters 92. The multiple first conveyors 71 are connected to the second transporter 72. The first conveyors 71 each receive a different type of stacked article group from the automated warehouses 91 through the first transporters 92. Each first conveyor 71 then transports the received stacked article group toward the second transporter 72 as a removed article group 81. The second transporter 72 receives the removed article groups 81 from the first conveyors 71 and sequentially transfers the removed article groups 81 to the second conveyor 73. The second conveyor 73 transports the multiple removed article groups 81 to the article layer supplier 20 in the order in which the second conveyor 73 receives the removed article groups 81 from the second transporter 72. In this example, the second transporter 72 is a transport vehicle that moves along a rail. However, the transporter is not limited to this example. The second transporter 72 may be, for example, a conveyor.

The support supplier 6 supplies, for the article layer transferrer 4, empty supports P (empty pallets) supporting no article. The support supplier 6 is connected to the article layer transferrer 4. In the illustrated example, the support supplier 6 includes a third conveyor 6a and a storing section 6b. The third conveyor 6a has one end connected to the article layer transferrer 4 and the other end serving as the storing section 6b. The storing section 6b can store multiple empty supports P. The empty supports P are transported by the third conveyor 6a from the storing section 6b to the article layer transferrer 4 as appropriate.

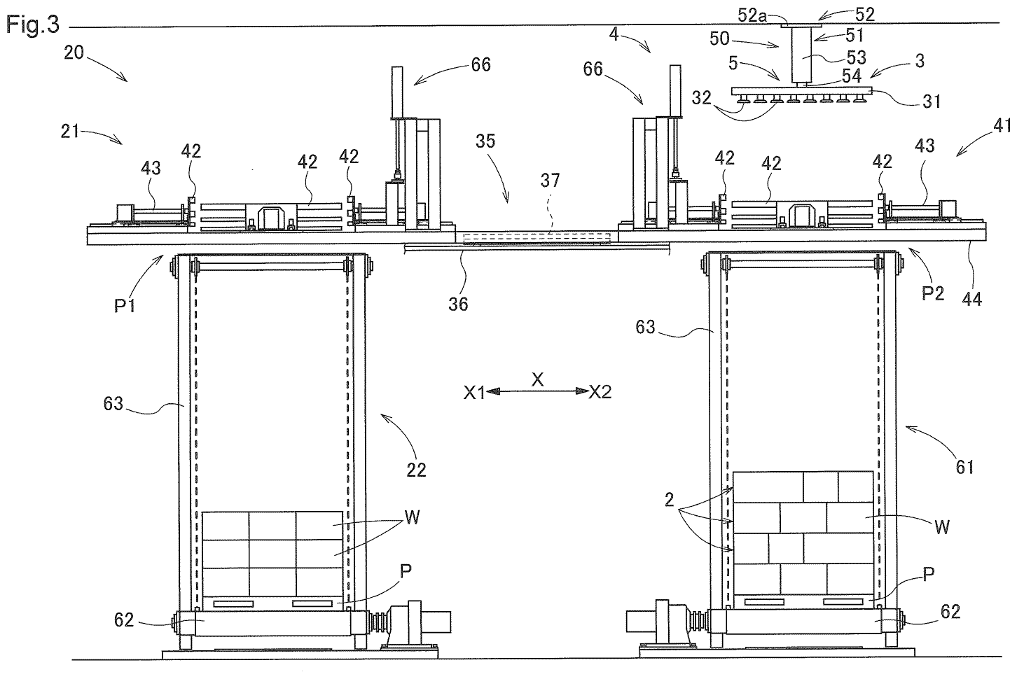

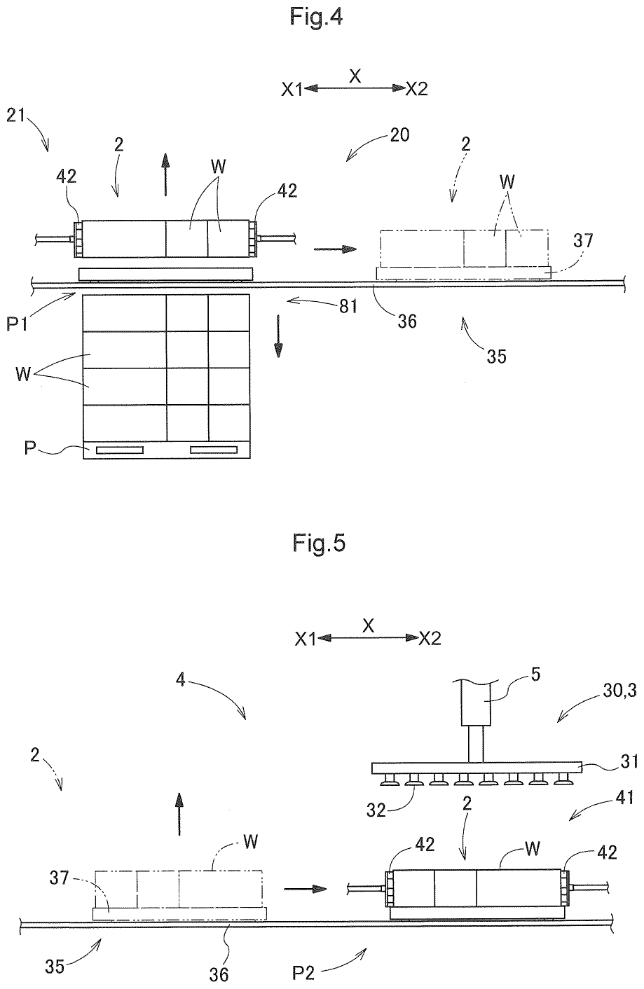

As shown in FIGS. 3 and 4, the article layer supplier 20 separates a group of articles, among the removed article group 81, in the top layer from the articles in the removed article group 81 in the layers lower than the top layer. The article layer supplier 20 then transports the separated article group to the article layer transferrer 4 as an article layer 2. The article layer 2 collectively refers to a group of articles W arranged in a planar manner. In this example, as shown in FIG. 3, the article layer supplier 20 is connected to the shipping article supplier 7 and the article layer transferrer 4. The article layer supplier 20 includes a first lifter 22 and a first gripper 21. The first lifter 22 includes a lifting platform 62 and posts 63 that guide vertical movement of the lifting platform 62. The lifting platform 62 receives, together with the support P, the removed article group 81 transported from the shipping article supplier 7 (the second conveyor 73 in this example). The first gripper 21 grips the article group in the top layer among the articles in the removed article group 81 stacked on the support P. The first gripper 21 includes multiple (four in this example) pressing members 42 and a drive (not shown) that causes the pressing members 42 to advance and retract. In this example, two pressing members 42 arranged separately in the first direction X and two pressing members 42 arranged separately in the second direction Y are disposed above the first lifter 22.

As shown in FIG. 4, when the lifting platform 62 ascends to place the removed article group 81 at a position corresponding to the first gripper 21 (at a first position P1 at which the article group in the top layer is surrounded by the four pressing members 42 in this example), each pressing member 42 moves toward the article group in the top layer (top article layer 2). The article group in the top layer is then pressed inward from both sides in the first direction X and both sides in the second direction Y by different pressing members 42. The lifting platform 62 then descends to separate the pressed article group in the top layer from the articles in the removed article group 81 in the layers lower than the top layer (FIG. 4). The first gripper 21 may include two pressing members 42. In this case, the first gripper 21 grips the article group in the top layer in either the first direction X or the second direction Y.

In this example, the article layer supplier 20 further includes a supply transporter 35. The supply transporter 35 transports, from the first position P1, the article layer 2 separated from the removed article group 81 to a second position P2. At the second position P2, the article layer 2 is surrounded by four pressing members 42 in a second gripper 41 (described later). The supply transporter 35 includes a transport portion 37 and a guide rail 36 that guides movement of the transport portion 37. The guide rail 36 connects the first position P1 to the second position P2. The guide rail 36 is disposed not to interfere with the removed article group 81 or the article layer 2. The article layer 2 separated from the removed article group 81 is placed on the transport portion 37 in the form of a plate when the pressing members 42 stop pressing. The transport portion 37 is then guided by the guide rail 36 from the first side X1 to the second side X2 in the first direction. This moves the article layer 2 from the first position P1 to the second position P2 (FIGS. 3 and 5).

The article layer transferrer 4 includes a holder 3 and a rotator 5 that rotates the holder 3 about a rotation axis. The article layer transferrer 4 also includes the second gripper 41 and a second lifter 61. The second gripper 41 grips the article layer 2 at the second position P2. The second lifter 61 is disposed below the second gripper 41 and overlaps the article layer 2 at the second position P2 as viewed vertically. In this example, the structure of the second gripper 41 is the same as the structure of the first gripper 21, and is not described specifically. The structure of the second lifter 61 is also the same as the structure of the first lifter 22, and is not described specifically. In this example, the second lifter 61 is connected to the support supplier 6 (the third conveyor 6a in this example). The lifting platform 62 in the second lifter 61 receives an empty support P (empty pallet) supplied from the support supplier 6.

The holder 3 holds, from above, the article layer 2 gripped by the second gripper 41. In this example, the holder 3 is a suction device. The holder 3 includes multiple suctioning parts 32 and a support plate 31 supporting the multiple suctioning parts 32. The suctioning parts 32 are aligned on a downward-facing surface of the support plate 31. In this example, the suctioning parts 32 are suction pads. The multiple suctioning parts 32 suck an upward-facing surface of the article layer 2.

In this example, the article layer transferrer 4 includes a mover 50 as the rotator 5. This allows the holder 3 to rotate about a vertical axis. In the example in FIG. 3, the mover 50 is disposed on the ceiling and supports the holder 3 from above. The mover 50 includes a support member 53 and a shaft 54. The shaft 54 has an end attached to the support plate 31 of the holder 3. The shaft 54 is rotatably supported by the support member 53. In this example, the support member 53 is hollow and accommodates the shaft 54 in the hollow portion to support the shaft 54. In this example, the article layer transferrer 4 also includes a lift 51. The holder 3 is thus movable vertically. The function of the lift 51 is implemented by the mover 50. In this example, the shaft 54 is vertically movable relative to the support member 53. The holder 3 can ascend and descend together with the shaft 54.

In this example, the article layer transferrer 4 also includes a horizontal mover 52 that moves the holder 3 horizontally (in the first direction X in this example). In this example, the horizontal mover 52 includes a horizontal guide 52a that guides the holder 3 in the first direction X. In the example in FIG. 3, the horizontal guide 52a is a rail on the ceiling and extends in the first direction X. The horizontal guide 52a supports the mover 50 from above. The rotator 5, the lift 51, and the horizontal mover 52 each include a drive (e.g., an electric motor) for moving the holder 3.

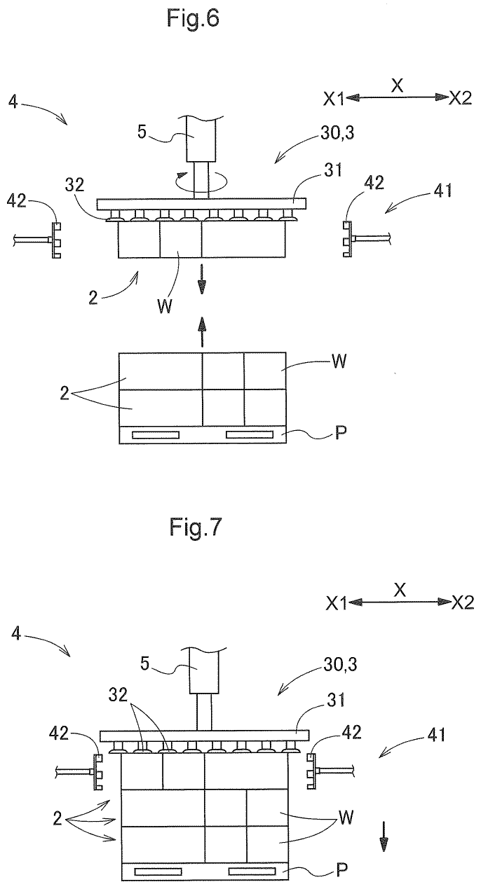

In the present embodiment, as shown in FIGS. 3 and 5 to 7, the article layer transferrer 4 moves the article layer 2 vertically and horizontally while collectively holding the articles W in the article layer 2 using the holder 3, and then stacks multiple article layers 2 vertically on the support P. In this example, as shown in FIG. 5, the article layer 2 separated at the first position P1 is transported to the second position P2 by the supply transporter 35. At the second position P2, the article layer 2 is pressed by the pressing members 42 in the second gripper 41. Thus, when the movement from the first position P1 to the second position P2 shifts articles in the article layer 2 and changes the overall shape of the article layer 2, the pressing from the pressing members 42 adjusts the overall profile of the article layer 2. As shown in FIG. 6, the holder 3 then descends toward the article layer 2 pressed (gripped) by the pressing members 42 and holds the article layer 2. In this example, the multiple suctioning parts 32 suck and hold the upper surface of the article layer 2. The second lifter 61 raises the lifting platform 62 to a position corresponding to the second position P2. As shown in FIG. 7, the holder 3 stacks the holding article layer 2 on the support P (or on a different article layer 2 on the support P) on the lifting platform 62. In response to the article layer 2 being stacked on the support P, each suctioning part 32 changes from a suctioning state to a releasing state. The support P on which the article layer 2 is stacked is a pallet in this example, but is not limited to the pallet and may be, for example, any container or conveyor. For example, the holder 3 may stack the article layer 2 on a transport surface of a shipping conveyor 48 (described below). In this case, the support P is the shipping conveyor 48.

In this example, the article layer transferrer 4 further includes the shipping conveyor 48. The shipping conveyor 48 connects the second lifter 61 to the travel path 93. The lifting platform 62 of the second lifter 61 receives multiple article layers 2 stacked on the support P. The multiple article layers 2 are transferred by the shipping conveyor 48 to the first transporters 92 on the travel path 93 as a shipping article group 82. The first transporters 92 transport the shipping article group 82 to, for example, destinations external to the article transport facility 90.

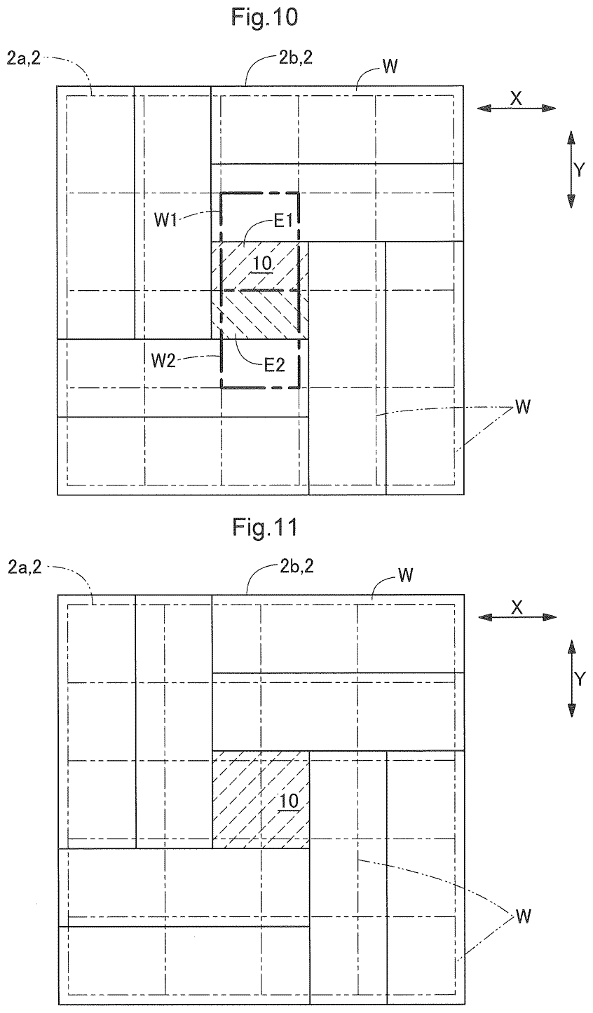

In this example, the article layers 2 (multiple articles arranged in a planar manner) to be stacked on the support P by the article layer transferrer 4 are arranged in a pattern predetermined for each type of article W. Examples include an arrangement pattern in which articles W are tiled to collectively define a rectangular or square shape as viewed vertically and an arrangement pattern in which articles W are arranged to surround an open area 10 at the center as viewed vertically (FIG. 10). In the arrangement pattern in this example, one article layer 2 includes articles W of the same type being arranged. Thus, different arrangement patterns are defined for different types of articles W. In this example, the automated warehouses 91 store stacked article groups by the types of articles W. The articles W in each layer (each level) of these stacked article groups are arranged based on the arrangement patterns that are set for each type of article W.

The article arrangement determination system 1 determines the arrangement of multiple articles W to vertically stack, on a support P, multiple article layers 2 each including multiple articles W arranged in a planar manner. In the present embodiment, the article arrangement determination system 1 includes a determination processor 11 and a modification processor 12. The article arrangement determination system 1 further includes a layer order determiner 13, an insertion determiner 14, and a storage 15. In the example described below, two article layers 2 adjacent to each other vertically include a lower article layer 2b and an upper article layer 2a. The lower article layer 2b is disposed lower than the upper article layer 2a.

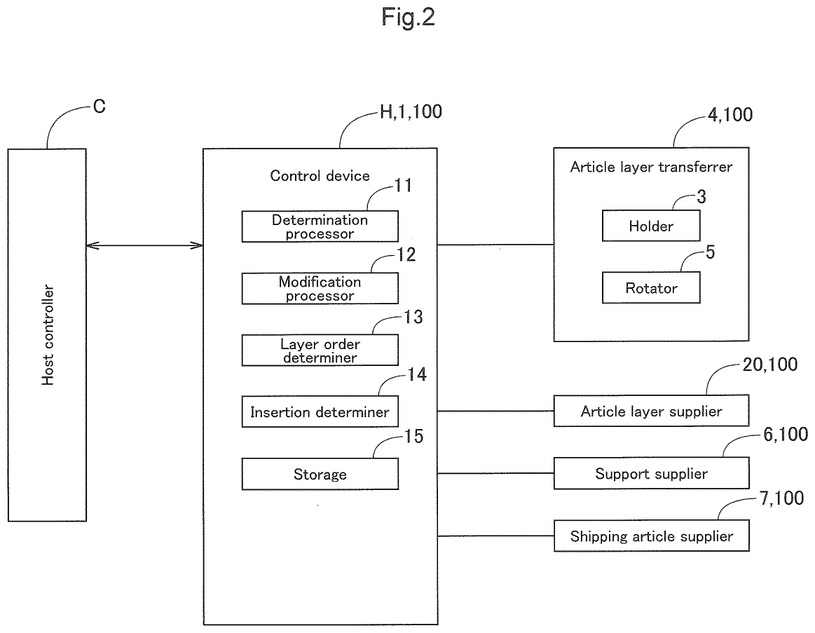

In the present embodiment, as shown in FIG. 2, the article stacking system 100 includes a control device H that controls the article layer transferrer 4, the article layer supplier 20, the support supplier 6, and the shipping article supplier 7. The functions of the article arrangement determination system 1 are implemented by the control device H. Thus, the control device H includes the determination processor 11, the modification processor 12, the layer order determiner 13, the insertion determiner 14, and the storage 15. In this example, a host controller C centrally controls the entire article transport facility 90. The control device H can communicate with the host controller C. The control device H and the host controller C each include, for example, a processor such as a microcomputer and peripheral circuitry including a memory. The functions of the components are implemented by the above hardware and a program executed on a processor such as a computer cooperating with each other. The storage 15 stores the arrangement pattern for each type of article W described above.

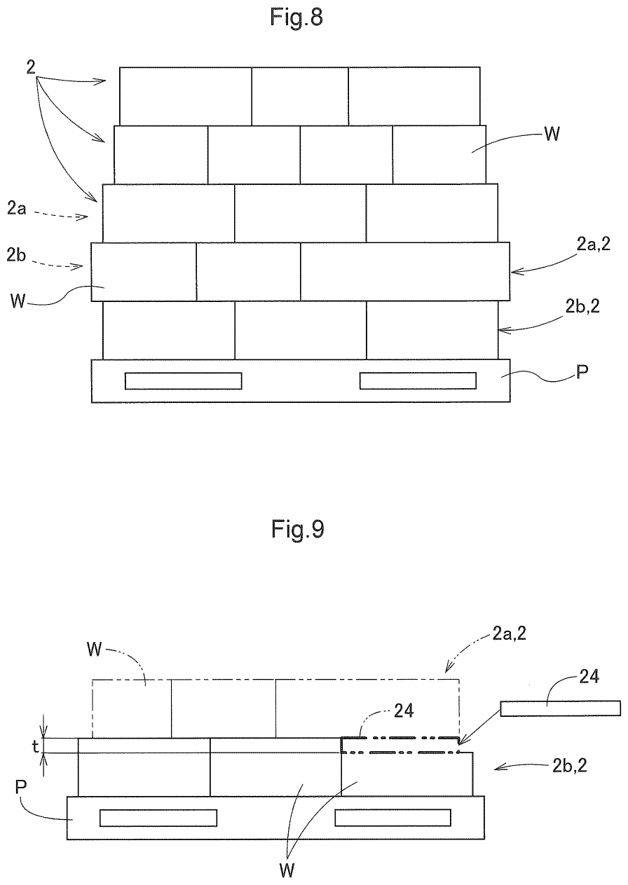

The layer order determiner 13 determines the order in which multiple article layers 2 are arranged vertically, as shown in FIG. 8. More specifically, in response to the control device H obtaining ordering information from the host controller C, the layer order determiner 13 determines, based on the ordering information, the order in which multiple article layers 2 are placed on the support P vertically. The ordering information includes, for example, information indicating stores as shipping destinations, the types of articles W to be shipped for each store, and the quantity of articles W for each type.

The layer order determiner 13 performs a basic process and an exceptional process. In the basic process, the order in which the article layers 2 are placed is determined to cause the layer areas inward from the edges of the article layers 2 as viewed vertically to be gradually smaller for upper layers from the bottom layer. The storage 15 stores, in addition to the arrangement pattern for each type of article W, the layer area of the article layer 2 forming each arrangement pattern in a manner associated with the weights (total weights) of the article layer 2. The layer area is an area including the open area 10. The layer order determiner 13 obtains, based on the type of article W to be stacked on one support P and the quantity of articles W for each type included in the ordering information, the arrangement pattern for each type of article W and data indicating the layer area for each arrangement pattern from the storage 15. The layer order determiner 13 then determines the order of the arrangement patterns to stack the article layers 2 on the support P starting from the arrangement pattern having the largest layer area. Thus, the resulting shipping article group 82 does not easily collapse. In the example in FIG. 8, the top article layer 2 to the third article layer 2 from the top are arranged in the order determined through the basic process.

The exceptional process is a process for switching the order in which the lower article layer 2b and the upper article layer 2a are placed when the total weight of the upper article layer 2a is greater than the total weight of the lower article layer 2b and the ratio of the layer area of the upper article layer 2a to the layer area of the lower article layer 2b is greater than or equal to a predetermined value. When, for example, the ratio of the layer area of the upper article layer 2a to the layer area of the lower article layer 2b is 95% or more, the layer order determiner 13 switches the order in which the lower article layer 2b and the upper article layer 2a are placed from the placement of the multiple article layers 2 determined based on the basic process. In the example in FIG. 8, the exceptional process is performed for the bottom article layer 2 and the article layer 2 immediately above the bottom layer. In the example described above, the exceptional process is performed when the ratio of the layer area of the upper article layer 2a to the layer area of the lower article layer 2b is 95% or more, but is not limited to this example. The exceptional process may be performed when the ratio is, for example, 90% or more.

As shown in FIG. 9, the insertion determiner 14 performs an insertion determination process for determining to insert a plate member 24 between the lower article layer 2b and the upper article layer 2a when the difference between the highest portion and the lowest portion of the upper surface of the lower article layer 2b is greater than or equal to a predetermined value. In this example, the insertion determination process may be performed when the difference between the highest portion and the lowest portion of the upper surface of the lower article layer 2b (difference t in level) is, for example, 3 cm or greater (t≥3). The insertion determination process may be performed at any time as appropriate. When articles W with different vertical dimensions are combined exceptionally to form one arrangement pattern, the insertion determination process may be performed at the time when the basic process is performed (or immediately after the basic process). This allows flattening the upper surface of the article layer 2 before the article layer 2 is stacked on the support P. The insertion determination process may also be performed at the time when the article layer 2 is separated from the shipping article group 82 by the article layer supplier 20. In this case, for example, a camera may be included in the article layer supplier 20. The difference in level described above may be calculated based on imaging information resulting from imaging the upper surface of the article layer 2 with the camera. The upper surface of the article layer 2 may be dented due to some factors but can be entirely flattened before the article layer 2 is stacked on the support P. In this example, the plate member 24 is a cardboard sheet, but may be, for example, a synthetic resin sheet, a synthetic resin board, or a wooden board. The plate member 24 may be inserted by, for example, a worker or a robot. The insertion determination process is not performed for the article layer 2 to be placed as the top layer.

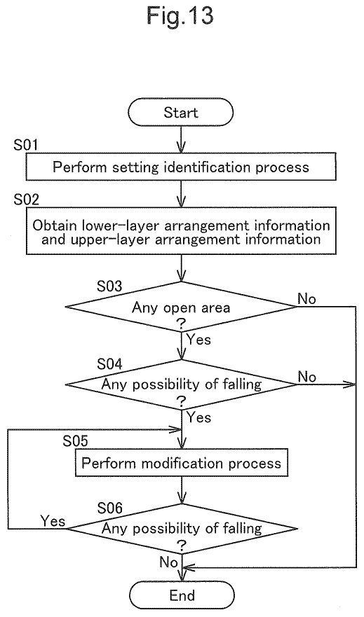

The determination processor 11 obtains lower-layer arrangement information indicating the lower-layer article arrangement, or specifically, the arrangement of multiple articles included in the lower article layer 2b, and upper-layer arrangement information indicating the upper-layer article arrangement, or specifically, the arrangement of multiple articles included in the upper article layer 2a. When the lower-layer article arrangement indicated by the lower-layer arrangement information has an open area 10 with no article W as viewed vertically, the determination processor 11 determines whether an article W included in the upper article layer 2a has the possibility of falling into the open area 10. In the present embodiment, the determination processor 11 performs its process after the arrangement of the multiple articles W to be stacked on the support P is tentatively determined through the basic process or the exceptional process. As shown in FIGS. 8 and 13, the determination processor 11 performs a setting identification process for identifying the position of the lower article layer 2b that is set for one of the multiple article layers 2 other than the top layer and the position of the upper article layer 2a that is set for the layer immediately above the lower article layer 2b (S01). The determination processor 11 then obtains the lower-layer arrangement information of the lower article layer 2b and the upper-layer arrangement information of the upper article layer 2a from the layer order determiner 13 (S02). The upper-layer arrangement information includes the arrangement pattern for the articles W included in the upper article layer 2a (upper-layer article arrangement). The lower-layer arrangement information includes the arrangement pattern for the articles W included in the lower article layer 2b (lower-layer article arrangement). The determination processor 11 determines whether the lower-layer article arrangement has an open area 10 by referring to the obtained information indicating the lower-layer article arrangement (S03). When determining that the lower-layer article arrangement has an open area 10 (Yes in S03), the determination processor 11 determines whether an article W has the possibility of falling (S04).

In the present embodiment, as shown in FIG. 10, the determination processor 11 determines whether an article W has the possibility of falling based on the ratio of the area of a first article W overlapping the open area 10 to the entire area of the first article W as viewed vertically. The first article W is one of the multiple articles W included in the upper article layer 2a. In this example, the determination as to whether an article W has the possibility of falling is performed for all the articles W (the articles W in the upper article layer 2a) overlapping the open area 10 as viewed vertically. FIGS. 10 to 12 are each a plan view of the lower article layer 2b in the lower-layer article arrangement (solid lines) overlapping the upper article layer 2a in the upper-layer article arrangement (two dotted lines).

In each figure, the open area 10 is hatched. In the example in FIG. 10, four articles W in the upper article layer 2a overlap the open area 10 as viewed vertically. The determination processor 11 selects, from the four articles W, two articles W having a greater ratio of overlapping with the open area 10 as a first overlapping article W1 and a second overlapping article W2, and determines whether the first overlapping article W1 and the second overlapping article W2 have the possibility of falling. More specifically, the determination processor 11 calculates the ratio of a first overlapping area E1 to the area of the upper surface of the first overlapping article W1. The first overlapping area E1 is an area of the first overlapping article W1 overlapping the open area 10. Similarly, the determination processor 11 calculates the ratio of a second overlapping area E2 to the area of the upper surface of the second overlapping article W2. The second overlapping area E2 is an area of the second overlapping article W2 overlapping the open area 10. The determination processor 11 can determine that the article W has the possibility of falling when the calculated ratio is greater than, for example, 40%. In this example, when multiple articles W overlap the open area 10, the determination processor 11 performs the determination as to whether an article W has the possibility of falling for the two articles W having larger overlapping areas. The determination processor 11 does not perform the determination for the other two article W apparently having smaller overlapping areas. However, the determination processor 11 can also perform the determination for all the articles W at least slightly overlapping the open area 10. The ratio used for determining that an article W has the possibility of falling may be, for example, 30% or more, and can be changed as appropriate. The determination processor 11 can also determine whether an article W has the possibility of falling under different conditions. The determination processor 11 may perform the determination as to the possibility of falling based on, for example, the weight or the shape of the upper surface of the article W overlapping the open area 10 as viewed vertically. The determination processor 11 may also perform the determination as to the possibility of falling based on a combination of the above ratio and a different condition. In the illustrated example, the open area 10 is at the center of the lower article layer 2b, but may be, for example, in a peripheral portion.

As shown in FIG. 13, the modification processor 12 modifies the upper-layer arrangement information when the determination processor 11 determines that an article W has the possibility of falling. In the present embodiment, when the determination processor 11 determines that an article W in the upper article layer 2a has the possibility of falling into the open area 10 in the lower article layer 2b (Yes in S04), the modification processor 12 performs a modification process for modifying the arrangement pattern for the upper article layer 2a (the upper-layer article arrangement) (S05). The modification processor 12 then generates modified arrangement information by modifying the upper-layer article arrangement indicated by the upper-layer arrangement information, and causes the determination processor 11 to determine whether an article W has the possibility of falling based on the upper-layer article arrangement indicated by the modified arrangement information. In response to the determination processor 11 determining that no article W has the possibility of falling, the modification processor 12 determines the modified arrangement information as new upper-layer arrangement information. In the present embodiment, after the modification process is performed by the modification processor 12, the determination processor 11 again determines whether an article W has the possibility of falling based on the upper-layer article arrangement indicated by the modified arrangement information (the modified arrangement pattern) (S06). When an article W is determined as having the possibility of falling (Yes in S06), the modification processor 12 performs the modification process again (S05). In this example, the modification processor 12 repeats the modification process and the determination processor 11 repeats its process (determination as to the possibility of falling) until no article W is determined as having the possibility of falling.

In the present embodiment, the modification processor 12 generates the modified arrangement information through at least one of a rotation process or a moving process performed for the upper-layer article arrangement indicated by the upper-layer arrangement information. In the rotation process, the upper-layer article arrangement is rotated about the rotation axis extending vertically. In the moving process, the upper-layer article arrangement is moved horizontally. The modification processor 12 may perform one of the rotation process or the moving process or both the rotation process and the moving process for the arrangement pattern for the upper article layer 2a (for the upper-layer article arrangement). In the present embodiment, as shown in FIG. 11, the modification processor 12 rotates the upper-layer article arrangement about the rotation axis by an integral multiple of 90°. In the example in FIG. 11, the upper-layer article arrangement shown in FIG. 10 is rotated by 90° about the rotation axis extending vertically. Thus, in this example, the upper-layer article arrangement in FIG. 10 is rotated by 90° when the determination processor 11 determines that an article W has the possibility of falling. The determination processor 11 then uses the rotated upper-layer article arrangement to again determine whether an article W has the possibility of falling. The modification processor 12 may also rotate the upper-layer article arrangement about the rotation axis by any integral multiple of 90°, or by an angle other than 90° (e.g., 180° or) 270°. The position of the rotation axis is at the center (the intersection of the two diagonal lines) of the rectangular upper article layer 2a as viewed vertically.

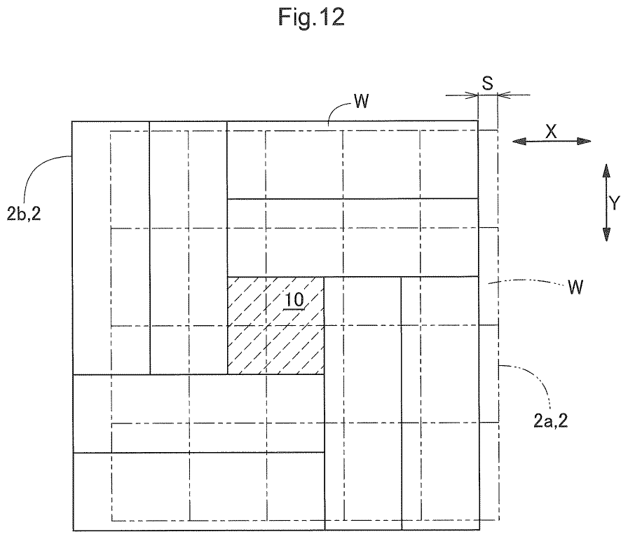

In the present embodiment, as shown in FIG. 12, the modification processor 12 moves, in the moving process, the upper-layer article arrangement horizontally within a range of a horizontal protruding extent S being less than or equal to a set value. The horizontal protruding extent S is an amount by which the edge of the upper article layer 2a protrudes horizontally from the edge of the lower article layer 2b as viewed vertically. In this example, the modification processor 12 moves, in the moving process, the upper-layer article arrangement in the first direction X. In the example in FIG. 12, the upper-layer article arrangement shown in FIG. 10 (dot-dash line) is moved in the first direction X. Thus, in this example, the upper-layer article arrangement in FIG. 10 is moved horizontally (in the first direction X in this example) when the determination processor 11 determines that an article W has the possibility of falling. The determination processor 11 then uses the moved upper-layer article arrangement to again determine whether an article W has the possibility of falling. In FIG. 12, after the moving process, the edge of the upper article layer 2a protrudes from the edge of the lower article layer 2b toward one side in the first direction X. The set value may be changed as appropriate based on the dimension of the protruding article W (the dimension in the first direction X in this example). For example, the set value may be, for example, 30% of the dimension of the protruding article W in the first direction X. The set value may also be a fixed value (e.g., 3 cm). The set value may be set based on, for example, the weight of the protruding article W. To perform the modification process by moving the upper-layer article arrangement in the second direction Y, the article layer transferrer 4 may be altered to allow the holder 3 to move in the second direction Y.

The determination processor 11 determines whether an article W has the possibility of falling based on the modified arrangement information generated through at least one of the rotation process or the moving process. In this example, the modification processor 12 performs both the rotation process and the moving process. The determination processor 11 determines whether an article W has the possibility of falling for the upper-layer article arrangement resulting from each process. The modification processor 12 generates the modified arrangement information based on the upper-layer article arrangement that is determined as not having the possibility of falling. When the upper-layer article arrangement resulting from each of the rotation process and the moving process is determined as not having the possibility of falling, the modification processor 12 generates the modified arrangement information based on, for example, the upper-layer article arrangement with the ratio calculated by the determination processor 11 being lower. The modification processor 12 may first perform one of the rotation process or the moving process. When the determination processor 11 determines that an article W has the possibility of falling, the modification processor 12 may then perform the other process. The modification processor 12 may repeat, for example, the moving process and the rotation process alternately until the determination processor 11 determines that no article has the possibility of falling.

In the present embodiment, as shown in FIG. 8, the article arrangement determination system 1 performs a layer-by-layer arrangement determination process. In the layer-by-layer arrangement determination process, the article arrangement determination system 1 determines the upper-layer arrangement information by setting the lowest article layer 2 among the multiple article layers 2 placed on the support P as the lower article layer 2b, setting the article layer 2 adjacent to and above the lower article layer 2b as the upper article layer 2a, and performing the process of the determination processor 11 and the process of the modification processor 12. The article arrangement determination system 1 then determines the overall arrangement of the multiple articles W to be stacked on the support P by setting, as the lower article layer 2b for the layer-by-layer arrangement determination process performed currently, the article layer 2 set as the upper article layer 2a for the layer-by-layer arrangement determination process performed previously, setting the article layer 2 adjacent to and above the lower article layer 2b set for the layer-by-layer arrangement determination process performed currently as the upper article layer 2a, and repeating the layer-by-layer arrangement determination process. The article arrangement determination system 1 repeats the layer-by-layer arrangement determination process when three or more article layers 2 are stacked on the support P.

In this example, as described above, the order in which the multiple article layers 2 are stacked on the support P is tentatively determined through the basic process and optionally through the exceptional process performed based on the ordering information.

The arrangement of the articles W in each article layer 2 is predetermined by pre-stored arrangement patterns. In other words, the arrangement of the multiple articles W to be stacked on the support P is tentatively determined by the basic process and optionally the exceptional process.

The layer-by-layer arrangement determination process is then performed once or multiple times for the multiple articles W in the tentatively determined arrangement. For three or more article layers 2 to be stacked on the support P, the top article layer 2 is set as the upper article layer 2a, and the article layer 2 immediately below the top layer is set as the lower article layer 2b. The layer-by-layer arrangement determination process is then repeated until the upper-layer article arrangement of the top article layer 2 is determined. Through this process, the arrangement pattern (upper-layer arrangement information) of the articles W in an article layer 2 determined as having the possibility of falling is modified, and the overall arrangement of the multiple articles W to be stacked on the support P is fixed. The article layer transferrer 4 stacks, on the support P, article layers 2 sequentially from the article layer 2 to be the bottom layer to the article layer 2 to be the top layer based on the fixed overall arrangement of the articles W (hereafter referred to as fixed arrangement information). When the modified arrangement information generated through the rotation process is determined as new upper-layer arrangement information, the article layer transferrer 4 rotates, based on the new upper-layer arrangement information, the article layer 2 held by the holder 3 about the rotation axis before stacking the article layer 2 on the support P. When the modified arrangement information generated through the moving process is determined as new upper-layer arrangement information, the article layer transferrer 4 also moves, based on the new upper-layer arrangement information, the article layer 2 held by the holder 3 horizontally (in the first direction X in this example) before stacking the article layer 2 on the support P. Further, when the modified arrangement information generated through both the rotation process and the moving process is determined as new upper-layer arrangement information, the article layer transferrer 4 rotates, based on the new upper-layer arrangement information, the article layer 2 held by the holder 3 about the rotation axis and moves, based on the new upper-layer arrangement information, the article layer 2 held by the holder 3 horizontally (in the first direction X in this example) before stacking the article layer 2 on the support P.

The control device H controls, based on the fixed arrangement information, the second transporter 72 and the second conveyor 73 to transport multiple removed article groups 81, which are removed from the automated warehouses 91 and transported to the shipping article supplier 7, to the article layer supplier 20 in an appropriate order (the order in which the articles are stacked on the support P). The control device H can thus separate, in the article layer supplier 20, article layers 2 from the removed article group 81 in the order in which the article layers 2 are stacked on the support P and transport the separated article layers 2 to the article layer transferrer 4. The host controller C controls, based on the ordering information, removing of multiple stacked article groups (removed article groups 81) from the automated warehouses 91 and transportation of the removed stacked article groups to the shipping article supplier 7 with the first transporters 92. When the articles W to be stacked on the support P include any remaining articles W (when the number of articles to be stacked is less than the number for forming a preset arrangement pattern), the remaining articles W can be additionally stacked by a robot in, for example, the shipping conveyor 48 after all the article layers 2 are stacked.

### OTHER EMBODIMENTS

(1) In the above embodiment, the arrangement (arrangement pattern) of the multiple articles W in an article layer 2 to be stacked on the support P is predetermined for each type of article W. However, the structure is not limited to this example. For example, the arrangement pattern may not be predetermined for each type of article W, and the article arrangement determination system 1 may determine the arrangement of the multiple articles W in each article layer 2 based on each piece of ordering information. In the above embodiment, the determination processor 11 and the modification processor 12 perform their processes based on the order of stacking the article layers 2 determined through the basic process or the exceptional process. However, the structure is not limited to this example. The determination processor 11 and the modification processor 12 may perform the processes based on the state of the article layers 2 actually stacked on the support P. For example, a camera may be installed to image the support P from above. The plan-view shape of the article layer 2 most recently stacked on the support P may be obtained from the imaging information generated by the camera. The determination processor 11 and the modification processor 12 may then use the obtained shape to perform their processes for the article layer 2 to be stacked next.
(2) In the above embodiment, the modification processor 12 generates the modified arrangement information through at least one of the rotation process for rotating, about the rotation axis extending vertically, the upper-layer article arrangement indicated by the upper-layer arrangement information or the moving process for moving the upper-layer article arrangement horizontally. However, the structure is not limited to this example. When any article layer 2 has the open area 10, for example, the modification processor 12 may determine the arrangement of the multiple articles W to be stacked on the support P to stack the article layer 2 first without the open area 10 on the support P and then the article layer 2 with the open area 10. This allows the article layer 2 with the open area 10 to be placed above the article layer 2 without the open area 10.
(3) In the above embodiment, the top article layer 2 is set as the upper article layer 2a, and the layer-by-layer arrangement determination process is repeated until the upper-layer arrangement information of the top article layer 2 is determined. However, the structure is not limited to this example. The layer-by-layer arrangement determination process may be performed as appropriate. More specifically, after the basic process and optionally the exceptional process are performed, the layer-by-layer arrangement determination process may be performed only for the article layer 2 with the open area 10 and the article layer 2 immediately above the article layer 2 with the open area 10. When no article layer 2 has the open area 10, the arrangement of all the articles W to be stacked on the support P can be fixed after the basic process and optionally the exceptional process are performed, without the layer-by-layer arrangement determination process being performed.
(4) In the above embodiment, the modification processor 12 rotates, in the rotation process, the upper-layer article arrangement about the rotation axis by an integral multiple of 90°. However, the structure is not limited to this example. The modification processor 12 may rotate, in the rotation process, the upper-layer article arrangement about the rotation axis by an angle other than the integral multiple of 90°. For example, the modification processor 12 may rotate the upper-layer article arrangement about the rotation axis by an integral multiple of 45°. In this manner, the rotation angle may be changed as appropriate based on, for example, the shape of the article layer 2.
(5) In the above embodiment, the modification processor 12 moves, in the moving process, the upper-layer article arrangement horizontally within the range of the horizontal protruding extent S being less than or equal to a set value. The horizontal protruding extent S is an amount by which the edge of the upper article layer 2a protrudes horizontally from the edge of the lower article layer 2b as viewed vertically. However, the structure is not limited to this example. The modification processor 12 may move, in the moving process, the upper article layer 2a in the upper-layer article arrangement within a range of not protruding from the lower article layer 2b horizontally.

In contrast, the upper article layer 2a in the upper-layer article arrangement after the exceptional process may be moved horizontally within the range of the protruding extent S being less than or equal to the set value, as described above.
(6) In the above embodiment, the determination processor 11 determines whether an article W has the possibility of falling based on the ratio of the area of a first article W overlapping the open area 10 to the entire area of the first article W as viewed vertically. The first article W is one of the multiple articles W included in the upper article layer 2a. However, the structure is not limited to this example. The article W (the article W included in the upper article layer 2a) overlapping the open area 10 as viewed vertically may fully cover the open area 10 in at least one of the first direction X or the second direction Y. In this case, the determination processor 11 may determine that no article has the possibility of falling, independently of the ratio of the area overlapping the open area 10.
(7) In the above embodiment, the article layer transferrer 4 moves the article layer 2 vertically and horizontally while collectively holding the articles W in the article layer 2 using the holder 3, and then stacks multiple article layers 2 vertically on the support P. However, the structure is not limited to this example. The article layer transferrer 4 may be, for example, a picking robot that stacks the articles W included in an article layer 2 one by one on the support P.
(8) The structure described in each of the above embodiments may be combined with any other structures described in the other embodiments unless any contradiction arises. This also applies to combinations of the embodiments described as other embodiments. For other structures as well, the embodiments described herein are merely illustrative in all aspects. Thus, the embodiments described herein may be modified variously as appropriate without departing from the spirit and scope of the disclosure.

### Overview of Embodiments

An overview of the article arrangement determination system and the article stacking system described above is provided below.

An article arrangement determination system according to an embodiment of the disclosure is a system for determining arrangement of a plurality of articles to vertically stack, on a support, a plurality of article layers each including articles of the plurality of articles arranged in a planar manner. The article arrangement determination system includes a determination processor and a modification processor. The determination processor obtains lower-layer arrangement information and upper-layer arrangement information. The lower-layer arrangement information indicates lower-layer article arrangement that is arrangement of the articles included in a lower article layer. The upper-layer arrangement information indicates upper-layer article arrangement that is arrangement of the articles included in an upper article layer. The lower article layer is a lower layer of two of the plurality of article layers adjacent to each other vertically. The upper article layer is an upper layer of the two of the plurality of article layers. The determination processor determines, in response to the lower-layer article arrangement indicated by the lower-layer arrangement information having an open area with no article as viewed vertically, whether an article included in the upper article layer has a possibility of falling into the open area. The modification processor modifies the upper-layer arrangement information in response to the determination processor determining that an article has the possibility of falling. The modification processor generates modified arrangement information by modifying the upper-layer article arrangement indicated by the upper-layer arrangement information, causes the determination processor to determine whether an article has the possibility of falling based on the upper-layer article arrangement indicated by the modified arrangement information, and determines the modified arrangement information as new upper-layer arrangement information in response to determination that no article has the possibility of falling.

When the article layers each including multiple articles are stacked vertically on the support, this structure can determine the arrangement of the articles to prevent an article in the upper article layer from falling into the open area in the lower article layer.

When an article is determined to have the possibility of falling into the open area in determining the arrangement of the articles, this structure generates the modified arrangement information by modifying the upper-layer article arrangement indicated by the upper-layer arrangement information to again determine whether an article has the possibility of falling. This structure can thus reliably determine appropriate arrangement of the articles without an article having the possibility of falling into the open area.

Thus, this structure can appropriately determine the arrangement of the multiple articles.

The modification processor may generate the modified arrangement information through at least one of a rotation process or a moving process performed for the upper-layer article arrangement indicated by the upper-layer arrangement information. The rotation process may be a process for rotating the upper-layer article arrangement about a rotation axis extending vertically, and the moving process may be a process for moving the upper-layer article arrangement horizontally.

In this structure, the modification processor generates the modified arrangement information through at least one of the rotation process or the moving process performed for the upper-layer article arrangement indicated by the upper-layer arrangement information. The modified arrangement information can thus be generated through a relatively simple process.

The article arrangement determination system may first perform a layer-by-layer arrangement determination process for determining the upper-layer arrangement information by setting, among the plurality of article layers to be stacked on the support, a lowest article layer as the lower article layer, setting an article layer above and adjacent to the lower article layer as the upper article layer, and performing a process of the determination processor and optionally a process of the modification processor. The article arrangement determination system may then determine overall arrangement of the plurality of articles to be stacked on the support by setting, as the lower article layer for the layer-by-layer arrangement determination process performed currently, the article layer set as the upper article layer for the layer-by-layer arrangement determination process performed previously, setting an article layer above and adjacent to the lower article layer for the layer-by-layer arrangement determination process performed currently as the upper article layer, and repeating the layer-by-layer arrangement determination process.

When three or more article layers are stacked on the support, this structure can appropriately determine the overall arrangement of the plurality of articles to prevent an article in the upper article layer from falling into the open area in the lower article layer.

Each of the plurality of articles may be rectangular as viewed vertically. Each of the plurality of article layers may have a rectangular profile as viewed vertically. The modification processor may rotate, in the rotation process, the upper-layer article arrangement about the rotation axis by an integral multiple of 90°.

This structure can generate the modified arrangement information that is a candidate for article arrangement with no possibility of falling through a simple process of rotating the upper-layer article arrangement indicated by the upper-layer arrangement information by an integral multiple of 90° about the rotation axis extending vertically.

The modification processor may move, in the moving process, the upper-layer article arrangement horizontally within a range of a horizontal protruding extent being less than or equal to a set value. The horizontal protruding extent may be an amount by which an edge of the upper article layer protrudes horizontally from an edge of the lower article layer as viewed vertically.

This structure can generate the modified arrangement information to prevent an article in the upper article layer from falling from the edge of the lower article layer after the upper-layer article arrangement indicated by the upper-layer arrangement information is moved horizontally.

The determination processor may determine whether an article has the possibility of falling based on a ratio of an area of a first article overlapping the open area to an entire area of the first article as viewed vertically. The first article may be one of the articles included in the upper article layer.

In this structure, the determination processor can appropriately determine the possibility of an article falling into the open area through a relatively simple process.

An article stacking system includes the article arrangement determination system described above and an article layer transferrer that vertically and horizontally moves, among the plurality of article layers, an article layer while holding the article layer with a holder and stacks the plurality of article layers vertically on the support. The article layer transferrer includes a rotator that rotates the holder about the rotation axis. The article layer transferrer rotates, in response to the modified arrangement information generated through the rotation process being determined as the new upper-layer arrangement information, the article layer held by the holder about the rotation axis based on the new upper-layer arrangement information before stacking the article layer on the support.

In this structure, the article layer transferrer rotates, in response to the modification processor generating the modified arrangement information through the rotation process performed on the initial upper-layer article arrangement and determining the modified arrangement information as the new upper-layer arrangement information, the holder with the rotator included in the article layer transferrer to stack the holding article layer on the support in an orientation based on the new upper-layer arrangement information. Thus, the multiple articles can be stacked on the support in appropriate arrangement without the possibility of falling.

The article arrangement determination system and the article stacking system according to one or more embodiments of the disclosure produce at least one of the advantageous effects described above.

What is claimed is:

1. An article arrangement determination system for determining arrangement of a plurality of articles to vertically stack, on a support, a plurality of article layers each including articles of the plurality of articles arranged in a planar manner, the article arrangement determination system comprising:
a determination processor configured to obtain lower-layer arrangement information and upper-layer arrangement information, the lower-layer arrangement information indicating lower-layer article arrangement that is arrangement of the articles included in a lower article layer, the upper-layer arrangement information indicating upper-layer article arrangement that is arrangement of the articles included in an upper article layer, wherein the lower article layer is a lower layer of two of the plurality of article layers adjacent to each other vertically, the upper article layer is an upper layer of the two of the plurality of article layers, and the determination processor is configured to determine, in response to the lower-layer article arrangement indicated by the lower-layer arrangement information having an open area with no article as viewed vertically, whether an article included in the upper article layer has a possibility of falling into the open area; and
a modification processor configured to modify the upper-layer arrangement information in response to the determination processor determining that an article has the possibility of falling, wherein the modification processor is configured to generate modified arrangement information by modifying the upper-layer article arrangement indicated by the upper-layer arrangement information, cause the determination processor to determine whether an article has the possibility of falling based on the upper-layer article arrangement indicated by the modified arrangement information, and determine the modified arrangement information as new upper-layer arrangement information in response to determination that no article has the possibility of falling.

2. The article arrangement determination system according to claim 1, wherein:
the modification processor generates the modified arrangement information through at least one of a rotation process or a moving process performed for the upper-layer article arrangement indicated by the upper-layer arrangement information, the rotation process is a process for rotating the upper-layer article arrangement about a rotation axis extending vertically, and the moving process is a process for moving the upper-layer article arrangement horizontally.

3. The article arrangement determination system according to claim 2, wherein:
the article arrangement determination system first performs a layer-by-layer arrangement determination process for determining the upper-layer arrangement information by setting, among the plurality of article layers to be stacked on the support, a lowest article layer as the lower article layer, setting an article layer above and adjacent to the lower article layer as the upper article layer, and performing a process of the determination processor and optionally a process of the modification processor, and
the article arrangement determination system then determines overall arrangement of the plurality of articles to be stacked on the support by setting, as the lower article layer for the layer-by-layer arrangement determination process performed currently, the article layer set as the upper article layer for the layer-by-layer arrangement determination process performed previously, setting an article layer above and adjacent to the lower article layer for the layer-by-layer arrangement determination process performed currently as the upper article layer, and repeating the layer-by-layer arrangement determination process.

4. The article arrangement determination system according to claim 2, wherein:
each of the plurality of articles is rectangular as viewed vertically,
each of the plurality of article layers has a rectangular profile as viewed vertically, and
the modification processor rotates, in the rotation process, the upper-layer article arrangement about the rotation axis by an integral multiple of 90°.

5. The article arrangement determination system according to claim 2, wherein:
the modification processor moves, in the moving process, the upper-layer article arrangement horizontally within a range of a horizontal protruding extent being less than or equal to a set value, and the horizontal protruding extent is an amount by which an edge of the upper article layer protrudes horizontally from an edge of the lower article layer as viewed vertically.

6. The article arrangement determination system according to claim 1, wherein:
the determination processor determines whether an article has the possibility of falling based on a ratio of an area of a first article overlapping the open area to an entire area of the first article as viewed vertically, and the first article is one of the articles included in the upper article layer.

7. An article stacking system, comprising:
the article arrangement determination system according to claim 2; and
an article layer transferrer configured to vertically and horizontally move, among the plurality of article layers, an article layer while holding the article layer with a holder and stack the plurality of article layers vertically on the support, the article layer transferrer comprising a rotator configured to rotate the holder about the rotation axis, wherein the article layer transferrer is configured to rotate, in response to the modified arrangement information generated through the rotation process being determined as the new upper-layer arrangement information, the article layer held by the holder about the rotation axis based on the new upper-layer arrangement information before stacking the article layer on the support.
